(19) United States
(12) Patent Application Publication
(10) Pub. No.: US 2015/0096590 A1
(43) Pub. Date: Apr. 9, 2015

(54) METHOD FOR CLEANING QUARTZ REACTION TUBE

(71) Applicant: UNITED MICROELECTRONICS CORP., Hsin-Chu City (TW)

(72) Inventors: Jheng-Sian Ni, Taichung City (TW); Li-Yuan Chang, Tainan City (TW); Chih-Ping Yen, Hsinchu City (TW); Fei-Yu Yang, Kaohsiung City (TW)

(73) Assignee: UNITED MICROELECTRONICS CORP., Hsin-Chu City (TW)

(21) Appl. No.: 14/049,216

(22) Filed: Oct. 9, 2013

(51) Int. Cl. B08B 9/027; B08B 1/00

(52) U.S. Cl. CPC B08B 9/027; B08B 1/005
USPC 134/3; 134/8; 15/93.1

(57) ABSTRACT

A method for cleaning quartz reaction tube is disclosed. The method includes the steps of: introducing a quartz reaction tube to a cleaning chamber, wherein the quartz reaction tube comprises a first end and a second end; sealing the first end and the second end of the quartz reaction tube with a first sealing element and a second sealing element respectively, wherein the first sealing element is coupled to an input pipe and a cleaning rod, and the second sealing element is coupled to an output pipe; supplying a first cleaning agent into the quartz reaction tube from the input pipe; utilizing the cleaning rod to perform a cleaning process; and expelling the first cleaning agent from the output pipe.

### BACKGROUND OF THE INVENTION

1. Field of the Invention

The invention relates to an apparatus and method for cleaning quartz reaction tube.

2. Description of the Prior Art

Thin film forming techniques such as chemical vapor deposition (CVD) and physical vapor deposition (PVD) are incorporated in semiconductor device manufacturing processes. As a thin film is formed by such a technique on a semiconductor substrate placed in a reaction chamber, a thin film is also grown on the inner wall of the reaction chamber and the surfaces of jigs. As the attached thin film becomes thick, for example, to several tens um, a fraction of the thin film peels off as particles. Particles may cause a low manufacturing yield. It is therefore necessary for a thin film forming apparatus to be subjected to routine cleaning for removing attached films.

Cleaning is broadly classified into wet cleaning and dry cleaning In a common wet cleaning process for cleaning silicon based thin films, a quartz reaction tube and jigs are dipped in a mixed solution of hydrofluoric acid and nitric acid. During the whole cleaning process, a thin film forming apparatus is cooled to the room temperature and disassembled into a quartz reaction tube and jigs which are then wet-cleaned and reassembled into a thin film forming apparatus which is again heated. The most common current process takes at least 16 to 24 hours.

The above approach however is not only time consuming but also cleans both the inner wall and outer wall of the quartz reaction tube, which in most cases consumes a great portion of the thickness and weight of the reaction tube so that a new tube has to be replaced within a very short period of time.

### SUMMARY OF THE INVENTION

It is therefore an objective of the present invention to provide an apparatus and method for cleaning quartz reaction tube for resolving the aforementioned drawbacks resulted from conventional techniques.

A method for cleaning quartz reaction tube is disclosed. The method includes the steps of: introducing a quartz reaction tube to a cleaning chamber, wherein the quartz reaction tube comprises a first end and a second end; sealing the first end and the second end of the quartz reaction tube with a first sealing element and a second sealing element respectively, wherein the first sealing element is coupled to an input pipe and a cleaning rod, and the second sealing element is coupled to an output pipe; supplying a first cleaning agent into the quartz reaction tube from the input pipe; utilizing the cleaning rod to perform a cleaning process; and expelling the first cleaning agent from the output pipe.

According to another aspect of the present invention, an apparatus for cleaning quartz reaction tube is disclosed. The apparatus includes a cleaning chamber for accommodating a quartz reaction tube, a first sealing element, and a second sealing element. The first sealing element is provided to seal a first end of the quartz reaction tube, in which the first sealing element is further coupled to an input pipe and a cleaning rod. The second sealing element is provided to seal a second end of the quartz reaction tube, in which the second sealing element is coupled to an output pipe.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of an apparatus for cleaning quartz reaction tube.

FIG. 2 illustrates an enlarged view of a quartz reaction tube according to a preferred embodiment of the present invention.

### DETAILED DESCRIPTION

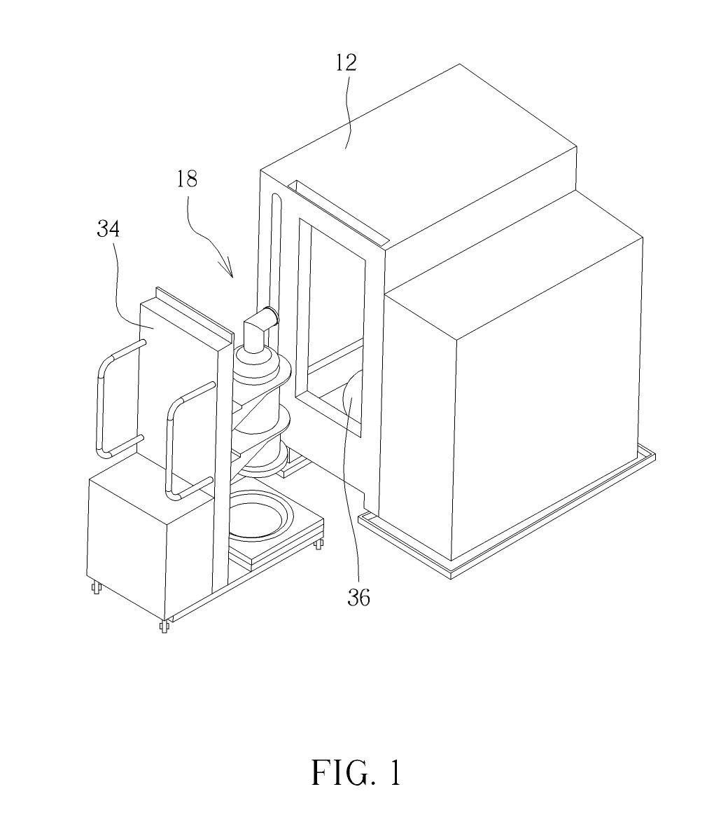

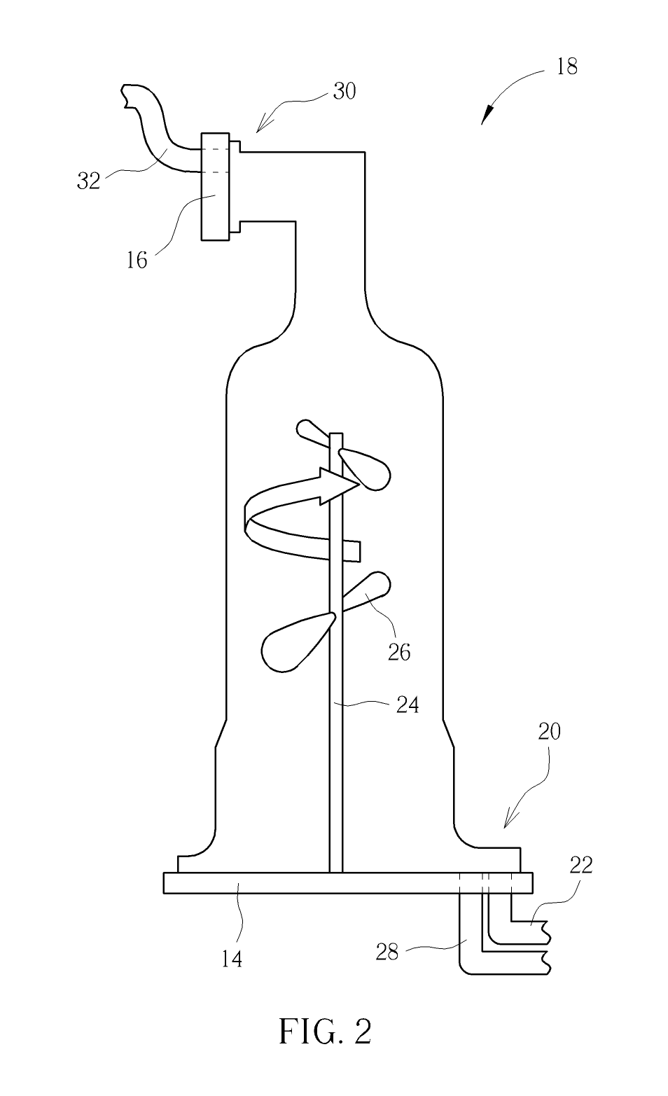

Referring to FIGS. 1-2, FIG. 1 illustrates a perspective view of an apparatus for cleaning quartz reaction tube, and FIG. 2 illustrates an enlarged view of a quartz reaction tube according to a preferred embodiment of the present invention.

Referring to FIGS. 1-2, an apparatus for cleaning quartz reaction according to a preferred embodiment of the present invention preferably includes a cleaning chamber 12, a first sealing element 14, and a second sealing element 16. The cleaning chamber 12 is preferably provided to accommodate a quartz reaction tube 18, which may have been utilized previously in thin film forming techniques such as CVD and/or PVD processes and may have also been coated with thin film residues and particles resulting from said processes.

The first sealing element 14 is provided to seal a first end 20 of the quartz reaction tube 18, in which the first sealing element 14 is coupled to an input pipe 22 and a cleaning rod 24. The cleaning rod 24 preferably includes a plurality of blades 26 thereon, which may be rotated along with the cleaning rod 24 in the direction indicated by the arrow as the cleaning rod 24 is electrically driven by a motor (not shown) embedded on the first sealing element 14. In addition to the input pipe 22 and the cleaning rod 24, a gas pipe 28 is also coupled to the first sealing element 14 so that gas may be injected through the gas pipe 28 into the quartz reaction tube 18 for drying the inner wall of the tube 18 after cleaning process is completed.

The second sealing element 16 is provided to seal a second end 30 of the quartz reaction tube 18, in which the second sealing element 16 is coupled to an output pipe 32 which may be used to direct liquid outside the quartz reaction tube 18.

According to a preferred embodiment of the present invention, both the first sealing element 14 and the second sealing element 16 are composed of Teflon, but not limited thereto.

A means for cleaning the quartz reaction tube is described below. First, as shown in FIG. 1, the quartz reaction tube 18 is introduced into the cleaning chamber 12. It should be noted that before introducing the quartz reaction tube 18 into the cleaning chamber 12, the quartz reaction tube 18 may be pre-cleaned.

The means for transporting the quartz reaction tube 18 and loading the tube into the cleaning chamber 12 for instance, may be accomplished by using a carrying vehicle 34, such as a fully automated loading vehicle. The carrying vehicle 34 first picks up the quartz reaction tube 18 with the first end 20 facing down while the second end 30 facing up, and then moves toward the cleaning chamber 12 to load and secure the quartz reaction tube 18 onto a pedestal 36 of the chamber 12.

After the quartz reaction tube 18 is fully secured inside the cleaning chamber 12, the first end 20 of the tube is sealed with the first sealing element 14 while the second end 30 of the tube is sealed with the second sealing element 16 respectively. As the two ends of the tube is sealed, the first sealing element 14 is further coupled with the input pipe 22 and cleaning rod 24 while the second sealing element 16 is coupled to the output pipe 32.

Next, a first cleaning agent is supplied from the input pipe 22 to the quartz reaction tube 18, in which the first cleaning agent preferably comprises hydrofluoric acid (HF), but not limited thereto.

A cleaning process is then carried out by using the cleaning rod 24 to clean the inner wall of the quartz reaction tube 18. Preferably, the cleaning process is conducted by spinning the cleaning rod 24 and the blades 26 so that the injected first cleaning agent could be carried in the spinning direction indicated by the arrow shown in FIG. 2 to rub against the inner wall of the quartz reaction tube 18 thereby readily removing thin film residues and particles accumulated on the inner wall of the tube. The first cleaning agent along with the removed residues is then expelled from the output pipe 32 through the second end 30.

After the first cleaning agent is expelled, a second cleaning agent, such as deionized water (DI water) is supplied into the quartz reaction tube 18 through the input pipe 22 or another individual input pipe (not shown) separating from the input pipe 22 to rinse the inner wall of the quartz reaction tube 18. Preferably, the rinsing process could be conducted by spinning the cleaning rod 24 and the blades 26 or without spinning the cleaning rod 24 and the blades 26, which are all within the scope of the present invention. The rinsing process preferably removes any other remaining particles or residues still attached to the inner wall of the tube.

After the quartz reaction tube 18 is rinsed with deionized water, nitrogen gas is supplied from the gas pipe 28 coupled to the first sealing element 14 to dry the interior of the tube. This completes the process for cleaning quartz reaction tube according to the preferred embodiment of the present invention.

Overall, the present invention provides a method for cleaning quartz reaction tube, which preferably introduces a quartz reaction tube to a cleaning chamber, seals a first end and second end of the quartz reaction tube with a first sealing element and second sealing element, supplies a cleaning agent into the tube and then uses a cleaning rod coupled to the tube to conduct a cleaning process, and finally expels the waste cleaning agent. Preferably, as only the inner wall of the quartz reaction tube is cleaned throughout the cleaning process, the present invention is able to minimize the damage resulted on both the inner and outer wall of the quartz reaction tube. In other words, less weight of the tube will be consumed throughout the cleaning process and the thickness of the tube could also be maintained.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for cleaning quartz reaction tube, comprising:
introducing a quartz reaction tube to a cleaning chamber, wherein the quartz reaction tube comprises a first end and a second end;
sealing the first end and the second end of the quartz reaction tube with a first sealing element and a second sealing element respectively, wherein the first sealing element is coupled to an input pipe and a cleaning rod, and the second sealing element is coupled to an output pipe;
supplying a first cleaning agent into the quartz reaction tube from the input pipe;
utilizing the cleaning rod to perform a cleaning process; and
expelling the first cleaning agent from the output pipe.

2. The method of claim 1, wherein the step of introducing the quartz reaction tube to the cleaning chamber further comprises:
pre-cleaning the quartz reaction tube;
utilizing a carrying vehicle to place and secure the quartz reaction tube onto a pedestal of the reaction chamber, wherein the first end of the quartz reaction tube faces downward and the second end of the quartz tube faces upward; and
sealing the first end and the second end of the quartz reaction tube.

3. The method of claim 1, wherein the first sealing element and the second sealing element comprise Teflon.

4. The method of claim 1, wherein the cleaning rod comprises a plurality of blades coupled to the cleaning rod.

5. The method of claim 4, further comprising spinning the cleaning rod and the blades after supplying the first cleaning agent into the quartz reaction tube.

6. The method of claim 1, wherein the first cleaning agent comprises hydrofluoric acid (HF).

7. The method of claim 1, further comprising supplying a second cleaning agent into the quartz reaction tube after supplying the first cleaning agent.

8. The method of claim 7, further comprising spinning the cleaning rod and the blades after supplying the first cleaning agent into the quartz reaction tube.

9. The method of claim 7, wherein the second cleaning agent comprises deionized water (DI water).

10. The method of claim 7, wherein the cleaning chamber further comprises a gas pipe coupled to the first sealing element.

11. The method of claim 10, further comprising injecting nitrogen gas into the quartz reaction tube through the gas pipe after supplying the second cleaning agent.

12. Apparatus for cleaning quartz reaction tube, said apparatus comprising:
a cleaning chamber for accommodating a quartz reaction tube, wherein the quartz reaction tube comprises a first end and a second end;
a first sealing element sealing the first end of the quartz reaction tube, wherein the first sealing element is coupled to an input pipe and a cleaning rod; and
a second sealing element sealing the second end of the quartz reaction tube, wherein the second sealing element is coupled to an output pipe.

13. The apparatus for cleaning quartz reaction tube of claim 12, wherein the first sealing element and the second sealing element comprise Teflon.

14. The apparatus for cleaning quartz reaction tube of claim 12, wherein the cleaning rod comprises a plurality of blades coupled to the cleaning rod.

15. The apparatus for cleaning quartz reaction tube of claim 12, wherein the cleaning chamber further comprises a gas pipe coupled to the first sealing element.
